(19) United States
(12) Patent Application Publication
(10) Pub. No.: US 2024/0059310 A1
(43) Pub. Date: Feb. 22, 2024

(54) METHOD FOR CONTROLLING DRIVE-THROUGH AND APPARATUS FOR CONTROLLING DRIVE-THROUGH

(71) Applicant: HYUNDAI MOBIS CO., LTD., Seoul (KR)

(72) Inventors: Douglas C. MacKenzie, Plymouth, MI (US); Gregory Baratoff, Mountain View, CA (US)

(73) Assignee: HYUNDAI MOBIS CO., LTD., Seoul (KR)

(21) Appl. No.: 17/890,443

(22) Filed: Aug. 18, 2022

(51) Int. Cl. B60W 60/00; G06Q 30/06; G06Q 30/04

(52) U.S. Cl. CPC B60W 60/001; G06Q 30/0635; G06Q 30/04; B60W 2554/4029; B60W 2554/4041; B60W 2555/60; B60W 2556/40; B60W 2552/50; B60W 2556/45

(57) ABSTRACT

A method for automatically driving a vehicle for a drive-through includes measuring a location of the vehicle with respect to physical features by a sensor mounted on the vehicle, detecting, by the sensor, nearby vehicles and pedestrians around the vehicle, and controlling driving of the vehicle based on information related to the location of the vehicle, the nearby vehicles, and the pedestrians.

### BACKGROUND

### Field of the Disclosure

The present embodiments are applicable to vehicles in all fields, for example, to an apparatus and method for supporting drive-through of a vehicle.

### Discussion of the Related Art

The Society of Automotive Engineers (SAE) has subdivided the autonomous driving into six levels, from level 0 to level 5, as follows.

Level 0 (No Automation) is a level in which the driver controls and takes responsibility for all driving. The driver drives the vehicle all the time, and the vehicle system only performs auxiliary functions such as emergency alerts. In this level, the driving control subject is the human, and the human is responsible for both driving and sensing of changes that occur during driving.

Level 1 (Driver Assistance) is a level that assists the driver through adaptive cruise control and lane keeping functions. The system is activated to assist the driver in maintaining the vehicle speed, inter-vehicle distance, and lane keeping. In this level, the driving control subjects are the human and the system, and the human is responsible for both driving and sensing of changes that occur during driving.

Level 2 (Partial Automation) is a level in which the vehicle and the human can simultaneously control steering and acceleration/deceleration of the vehicle for a period of time under specific conditions. Assistive driving is possible when steering in gentle curves and maintaining a distance from the vehicle in front. In this level, however, the human is responsible for both driving and sensing of changes that occur during driving, and the driver always needs to monitor the driving situation. Also, in situations that the system fails to recognize, the driver must immediately intervene in driving.

Level 3 (Partial Automation) is a level in which the system is responsible for driving in a section under specific conditions, such as a highway, and the driver intervenes only in case of danger. The system takes responsibility for driving control and sensing of changes during driving. Unlike in Level 2, the monitoring is not required. However, if the system's requirements are exceeded, the system requests immediate intervention from the driver.

Level 4 (High Automation) enables autonomous driving on most roads. Both driving control and driving responsibility rest with the system. Driver intervention is unnecessary on most roads except in restricted situations. However, since driver intervention may be requested under certain conditions, such as bad weather, a device for driving control through a human is required.

Level 5 (Full Automation) is a level in which a driver is not required for driving and driving can be performed with only occupants. The occupant only inputs the destination, and the system takes responsibility for driving in all conditions. In Level 5, control devices for steering, acceleration, and deceleration of the vehicle are unnecessary.

In Korea, the safety regulations for Level 3 were prepared in 2020 in consideration of the international trends being discussed at the World Forum on Harmonization of Vehicle Regulations under the UN (UN/ECE/WP.29).

However, a problem with recently employed semi-autonomous and autonomous driving systems is that the driving assistance system operates only in a very limited manner around toll gates on highways.

For example, conventional technology provides information on the high-pass driving lane at a highway toll gate using a navigation system or the like, but has failed to provide a solution for guiding or automatically controlling a specific high-pass lane or a specific cash tollgate lane according to the vehicle, and driving route conditions, and the like.

### SUMMARY

This Summary is provided to introduce a selection of concepts in simplified form that are further described below in the Detailed Description. This Summary is not intended to identify key features or essential features of the claimed subject matter, nor is it intended to be used as an aid in determining the scope of the claimed subject matter.

An object of the present embodiments devised to solve the above-described problems is to provide a method and apparatus for drive-through assist (DTA) capable of reducing driver stress and waiting time.

Another object of the present embodiments is to provide a method/apparatus for safely controlling a vehicle in a certain area.

Another object of the present embodiments is to provide a vehicle control, order, and payment method for efficient and safe drive-through.

Another object of the present embodiments is to provide a method/apparatus for controlling manual driving and automatic driving of a vehicle.

It will be appreciated by persons skilled in the art that the objects that could be achieved with the present disclosure are not limited to what has been particularly described hereinabove and the above and other objects that the present disclosure could achieve will be more clearly understood from the following detailed description.

In one general aspect, a method for controlling a vehicle includes measuring a location of the vehicle with respect to physical features by a sensor mounted on the vehicle, detecting, by the sensor, nearby vehicles and pedestrians around the vehicle, and controlling driving of the vehicle based on information related to the location of the vehicle, the nearby vehicles, and the pedestrians.

The physical features may include lane markings and sign information for the vehicle.

The method may include moving or stopping the vehicle.

The method may include receiving a map for the vehicle, the map may include location information for the vehicle and information related to a place for the drive-through, and the vehicle may be controlled based on the map.

The map may be received before the vehicle arrives at the place for the drive-through.

The map may be downloaded from a server based on a communication network when the vehicle is close to the place for the drive-through, the map may be generated based on data collected in manually driving the vehicle for the drive-through, the map may be transmitted to the nearby vehicles for the drive-through, and the map may be updated in the vehicle and transmitted to the nearby vehicles.

In another general aspect, a vehicle for providing automatic driving for a drive-through includes: a sensor configured to measure a location of the vehicle with respect to physical features, the sensor being mounted on the vehicle; and a processor configured to detect nearby vehicles and pedestrians around the vehicle by the sensor and to control driving of the vehicle based on information related to the location of the vehicle, the nearby vehicles, and the pedestrians.

In another general aspect, a system for processing an order from a vehicle for a drive-through includes a communicator configured to receive menu information for ordering, a display configured to display the menu information for the vehicle, and a processor configured to receive an order from a driver or a passenger of the vehicle, wherein the order is transmitted via the communicator.

In another general aspect, a computer-readable recording medium may store data measured by a sensor of a vehicle and indicative of a location of the vehicle with respect to physical features, data generated by detecting nearby vehicles and pedestrians around the vehicle, and data for controlling driving of the vehicle based on information related to the location of the vehicle, the nearby vehicles, and the pedestrians.

It is to be understood that both the foregoing general description and the following detailed description of the present disclosure are exemplary and explanatory and are intended to provide further explanation of the disclosure as claimed.

Embodiments may increase the convenience for a driver of a vehicle. Embodiments may effectively alleviate the burden and stress that the driver of the vehicle has to manually navigate the way for a drive-through. According to embodiments, the driver may easily and safely control the vehicle. Effects provided by the present embodiments are not limited to the effects mentioned herein, and other effects can be clearly understood by those skilled in the art from the detailed description of the disclosure.

The effects obtainable in the present disclosure are not limited to the above-mentioned effects, and other effects not mentioned may be clearly understood by those of ordinary skill in the art from the following description.

Other features and aspects will be apparent from the following detailed description, the drawings, and the claims.

### BRIEF DESCRIPTION OF THE DRAWINGS

The accompanying drawings, which are included to provide a further understanding of the disclosure, illustrate embodiments of the disclosure and together with the description serve to explain the principle of the disclosure. For better understanding of various embodiments to be described below, the description of the following embodiments should be referred to in relation to the drawings including parts corresponding to similar reference numerals across the following drawings. In the drawings:

FIG. 1 is an overall block diagram of an autonomous driving control system to which an autonomous driving apparatus according to any one of embodiments of the present disclosure may be applied;

FIG. 2 is an exemplary diagram illustrating an example in which an autonomous driving apparatus according to any one of embodiments of the present disclosure is applied to a vehicle;

FIG. 3 illustrates a vehicle control method according to embodiments;

FIG. 4 illustrates drive-through control according to embodiments;

FIG. 5 illustrates drive-through control according to embodiments; and

FIG. 6 illustrates a vehicle control method according to embodiments.

### DETAILED DESCRIPTION

Reference will now be made in detail to the exemplary embodiments of the present disclosure, examples of which are illustrated in the accompanying drawings. The detailed description, which will be given below with reference to the accompanying drawings, is intended to explain exemplary embodiments of the present disclosure, rather than to show the only embodiments that can be implemented according to the present disclosure. The following detailed description includes specific details in order to provide a thorough understanding of the embodiments. However, it will be apparent to those skilled in the art that the embodiments can be practiced without such specific details.

Although most terms used in the embodiments have been selected from general ones widely used in the art, some terms have been arbitrarily selected by the applicant and their meanings are explained in detail in the following description as needed. Thus, the embodiments should be understood based upon the intended meanings of the terms rather than their simple names or meanings.

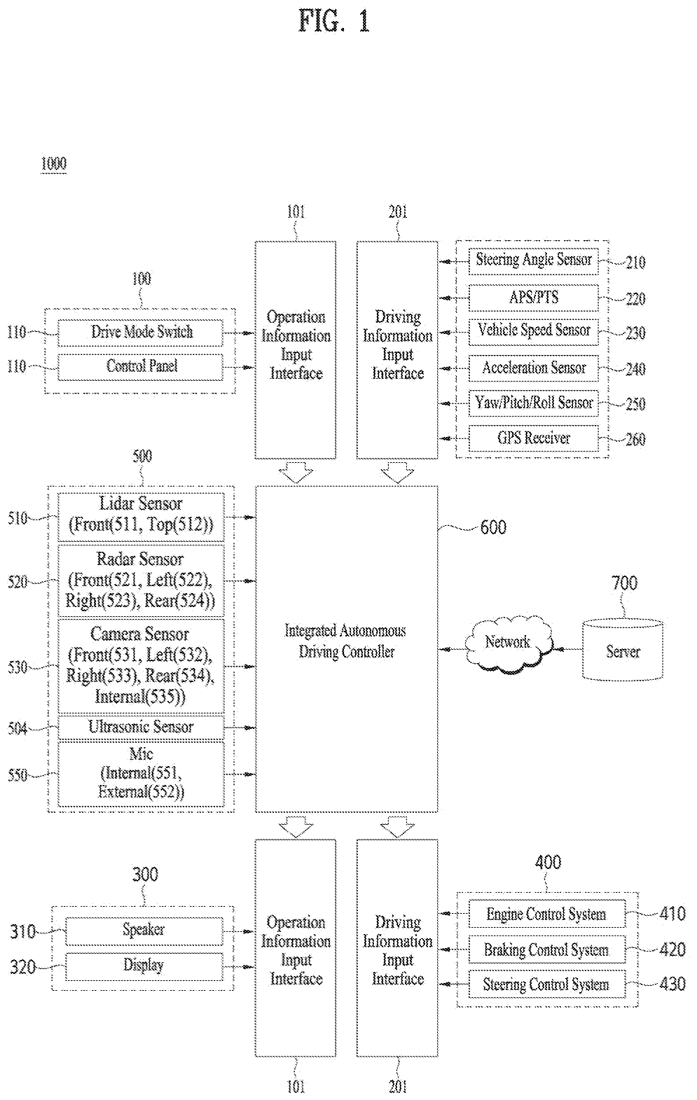

FIG. 1 is an overall block diagram of an autonomous driving control system to which an autonomous driving apparatus according to any one of embodiments of the present disclosure may be applied.

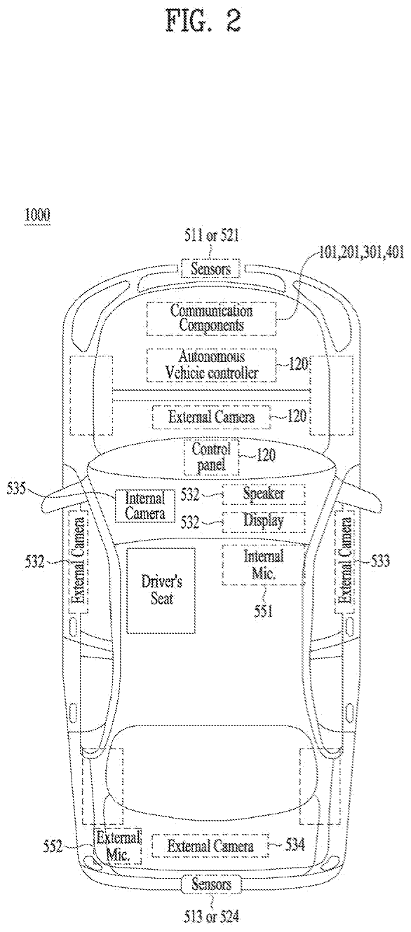

FIG. 2 is an exemplary diagram illustrating an example of application of an autonomous driving apparatus according to one of embodiments of the present disclosure to a vehicle.

Hereinafter, a structure and function of an autonomous driving control system (e.g., an autonomous driving vehicle) to which the autonomous driving apparatus according to the embodiments is applicable will be described with reference to FIGS. 1 and 2.

As shown in FIG. 1, the autonomous driving vehicle 1000 may be implemented around an integrated autonomous driving controller 600 configured to transmit and receive data for control of autonomous driving of the vehicle through an operation information input interface 101, a driving information input interface 201, an occupant output interface 301, and a vehicle control output interface 401. In the present disclosure, the integrated autonomous driving controller 600 may be referred to as a controller, a processor, or a control unit.

The integrated autonomous driving controller 600 may acquire, through the operation information input interface 101, operation information according to the operation of the occupant on the user input unit 100 in an autonomous driving mode or a manual driving mode of the vehicle. As shown in FIG. 1, the user input unit 100 may include a driving mode switch 110 and a control panel 120 (e.g., a navigation terminal mounted on the vehicle, a smartphone or tablet carried by the occupant, etc.). Accordingly, the driving information may include driving mode information and navigation information about the vehicle.

For example, the driving mode (i.e., the autonomous driving mode/manual driving mode or sports mode/eco mode/safe mode/normal mode) of the vehicle, which is determined according to the operation of the driving mode switch 110 by the occupant, may be transmitted to the integrated autonomous driving controller 600 via the operation information input interface 101 as the above-described operation information.

Also, navigation information such as the occupant's destination and the route to the destination (the shortest route or preferred route selected by the occupant among candidate routes to the destination) input by the occupant through the control panel 120 may be transmitted as the operation information to the integrated autonomous driving controller 600 via the input interface 101.

The control panel 120 may be implemented as a touch screen panel that provides a user interface (UI) allowing the driver to input or modify information for autonomous driving control of the vehicle. In this case, the driving mode switch 110 described above may be implemented as a touch button on the control panel 120.

Also, the integrated autonomous driving controller 600 may acquire driving information indicating the driving state of the vehicle via the driving information input interface 201. The driving information may include a steering angle formed when the occupant manipulates a steering wheel, an accelerator pedal stroke or brake pedal stroke formed when the accelerator pedal or the brake pedal is depressed, and a variety of information indicating the driving state and behavior of the vehicle, such as vehicle speed, acceleration, yaw, pitch and roll behaviors formed in the vehicle. Each piece of the driving information may be detected by a driving information detector 200, which may include a steering angle sensor 210, an accelerator position sensor (APS)/pedal travel sensor (PTS) 220, a vehicle speed sensor 230, an acceleration sensor 240, and a yaw/pitch/roll sensor 250 as shown in FIG. 1.

Furthermore, the driving information about the vehicle may include location information about the vehicle. The location information about the vehicle may be acquired through a global positioning system (GPS) receiver 260 applied to the vehicle. The driving information may be transmitted to the integrated autonomous driving controller 600 via the driving information input interface 201 and utilized to control the driving of the vehicle in the autonomous driving mode or the manual driving mode of the vehicle.

Also, the integrated autonomous driving controller 600 may transmit driving state information, which is provided to the occupant in the autonomous driving mode or the manual driving mode of the vehicle, to an output unit 300 via the occupant output interface 301. That is, the integrated autonomous driving controller 600 may transmit the driving state information about the vehicle to the output unit 300, such that the occupant may check whether the vehicle is in the autonomous driving state or the manual driving state based on the driving state information output through the output unit 300. The driving state information may include various kinds of information indicating the driving state of the vehicle, such as, for example, a current driving mode, a shift range, and a vehicle speed.

In addition, upon determining that a warning needs to be issued to the driver in the autonomous driving mode or manual driving mode of the vehicle along with the driving state information, the integrated autonomous driving controller 600 may transmit warning information to the output unit 300 via the occupant output interface 301 such that the output unit 300 outputs a warning to the driver. In order to audibly and visually output the driving state information and the warning information, the output unit 300 may include a speaker 310 and a display 320 as shown in FIG. 1. In this case, the display 320 may be implemented as the same device as the aforementioned control panel 120 or as a separate and independent device.

Also, the integrated autonomous driving controller 600 may transmit, via the vehicle control output interface 401, control information for control of driving of the vehicle in the autonomous driving mode or manual driving mode of the vehicle to a sub-control system 400 applied to the vehicle. As shown in FIG. 1, the sub-control system 400 for control of driving of the vehicle may include an engine control system 410, a braking control system 420, and a steering control system 430. The integrated autonomous driving controller 600 may transmit engine control information, braking control information, and steering control information as the control information to each of the sub-control systems 410, 420, and 430 via the vehicle control output interface 401. Accordingly, the engine control system 410 may control the speed and acceleration of the vehicle by increasing or decreasing the fuel supplied to the engine, and the braking control system 420 may control braking of the vehicle by adjusting the vehicle braking force. Also, the steering control system 430 may control the steering of the vehicle through a steering system (e.g., a motor driven power steering (MDPS) system) applied to the vehicle.

As described above, the integrated autonomous driving controller 600 of this embodiment may acquire operation information according to the driver's manipulation and driving information indicating the driving state of the vehicle via the operation information input interface 101 and the driving information input interface 201, respectively, and may transmit driving state information and warning information generated according to the autonomous driving algorithm to the output unit 300 via the occupant output interface 301. It may also transmit control information generated according to the autonomous driving algorithm to the sub-control system 400 via the vehicle control output interface 401 such that driving control of the vehicle is performed.

In order to ensure stable autonomous driving of the vehicle, it is necessary to continuously monitor the driving state by accurately measuring the driving environment of the vehicle and to control driving according to the measured driving environment. To this end, the autonomous driving apparatus of this embodiment may include a sensor unit 500 configured to detect objects around the vehicle, such as nearby vehicles, pedestrians, roads, or fixed facilities (e.g., traffic lights, mileposts, traffic signs, construction fences, etc.), as shown in FIG. 1.

As shown in FIG. 1, the sensor unit 500 may include at least one of a light detection and ranging (LiDAR) sensor 510, a radar sensor 520, and a camera sensor 530 to detect a nearby object outside the vehicle.

The LiDAR sensor 510 detect a nearby object outside the vehicle by transmitting a laser signal to the vicinity of the vehicle and receiving a returning signal that is reflected on the object. The LiDAR sensor 510 may detect a nearby object located within a set distance, a set vertical field of view, and a set horizontal field of view, which are predefined according to the specification of the sensor. The LiDAR sensor 510 may include a front LiDAR sensor 511, a top LiDAR sensor 512, and a rear LiDAR sensor 513 installed at the front, top, and rear of the vehicle, respectively. However, the installation locations and the number of installations are not limited to a specific embodiment. A threshold for determining the validity of a returning laser signal reflected on the object may be pre-stored in a memory (not shown) of the integrated autonomous driving controller 600. The integrated autonomous driving controller 600 may determine the location of an object (including the distance to the object) and the speed and movement direction of the object by measuring the time taken for the laser signal transmitted through the LiDAR sensor 510 to be reflected on the object and return.

The radar sensor 520 may detect a nearby object outside the vehicle by emitting electromagnetic waves to the vicinity of the vehicle and receiving a returning signal that is reflected on the object. The radar sensor 520 may detect a nearby object located within a set distance, a set vertical field of view, and a set horizontal field of view, which are predefined according to the specification of the sensor. The radar sensor 520 may include a front radar sensor 521, a left radar sensor 522, a right radar sensor 523, and a rear radar sensor 524 installed on the front, left, right and rear surfaces of the vehicle, respectively. However, the installation locations and the number of installations are not limited to a specific embodiment. The integrated autonomous driving controller 600 may determine the location of an object (including the distance to the object) and the speed and movement direction of the object by analyzing the power of electromagnetic waves transmitted and received through the radar sensor 520.

The camera sensor 530 may detect nearby objects outside the vehicle by capturing an image of the surroundings of the vehicle, and may detect nearby objects located within a set distance, set vertical angle of view, and set horizontal angle of view, which are predefined according to the specification of the sensor.

The camera sensor 530 may include a front camera sensor 531, a left camera sensor 532, a right camera sensor 533, and a rear camera sensor 534 installed on the front, left, right and rear surfaces of the vehicle, respectively. However, the installation locations and the number of installations are not limited to a specific embodiment. The autonomous driving integrated controller 600 may determine may determine the location of an object (including the distance to the object) and the speed and movement direction of the object by applying predefined image processing to the image captured by the camera sensor 530.

In addition, an internal camera sensor 535 configured to capture an image of the inside of the vehicle may be mounted at a predetermined position (e.g., the rear view mirror) inside the vehicle, and the integrated autonomous driving controller 600 may monitor the behavior and state of the occupant based on the image acquired through the internal camera sensor 535 and output a guide or warning to the occupant through the above-described output unit 300.

In addition to the LiDAR sensor 510, the radar sensor 520, and the camera sensor 530, the sensor unit 500 may further include an ultrasonic sensor 540 as shown in FIG. 1. Also, various types of sensors for detecting objects around the vehicle may be further employed for the sensor unit 500.

FIG. 2 provided for understanding of this embodiment illustrates that the front LiDAR sensor 511 or the front radar sensor 521 is installed on the front side of the vehicle, the rear LiDAR sensor 513 or the rear radar sensor 524 is installed on the rear side of the vehicle, and the front camera sensor 531, the left camera sensor 532, the right camera sensor 533 and the rear camera sensor 534 are installed on the front side, left side, right side and rear side of the vehicle, respectively. However, as described above, the installation locations and number of installations of the sensors are not limited to a specific embodiment.

Furthermore, in order to determine the condition of the occupant in the vehicle, the sensor unit 500 may further include a biometric sensor configured to detect the occupant's bio-signals (e.g., heart rate, electrocardiogram, respiration, blood pressure, body temperature, brain waves, blood flow (pulse wave), blood sugar, etc.). The biometric sensor may include a heart rate sensor, an electrocardiogram sensor, a respiration sensor, a blood pressure sensor, a body temperature sensor, an electroencephalogram sensor, a photoplethysmography sensor, and a blood sugar sensor.

Finally, the sensor unit 500 may additionally include a microphone 550. The microphone 550 may include an internal microphone 551 and an external microphone 552, which are used for different purposes, respectively.

The internal microphone 551 may be used, for example, to analyze the voice of an occupant in the autonomous driving vehicle 1000 based on Al or to immediately respond to a direct voice command.

On the other hand, the external microphone 552 may be used, for example, to appropriately operate for safe driving by analyzing various sounds generated from the outside of the autonomous driving vehicle 1000 using various analysis tools such as deep learning.

For reference, the components of the reference numerals shown in FIG. 2 may perform the same or similar functions as those shown in FIG. 1. Compared to FIG. 1, FIG. 2 illustrates the positional relationship between components (with respect to the inside of the autonomous driving vehicle 1000) in detail.

The LiDAR sensor may be used together with cameras and radars in environment recognition required for advanced driver assistance systems (ADAS) and autonomous driving (AD) automotive applications.

LiDAR may provide accurate range measurements of the environment. Thereby, the exact distances to moving objects and stationary objects in the environment may be estimated, and obstacles on a driving path may be sensed.

To use an environment recognition sensor for ADAS/AD applications, it is necessary to identify the sensor's pose, i.e., the sensor's position and orientation, with respect to a vehicle reference frame (VRF) such that the sensor's readings may be displayed in the VRF. The VRF for ADAS/AD may generally be defined as the center of the rear axle above the rear axle or just below the ground.

The process of determining the pose may be a kind of external calibration. The calibration performed while the vehicle is running on the road may be referred to as auto-calibration (AC).

Embodiments may improve offline LiDAR calibration. This operation may be performed as an end-of-line (EOL) calibration at the factory or a service calibration at a repair shop. However, it may be performed when the sensor is misaligned due to a shock caused by an accident or after the sensor removed for repair is reassembled.

Resources available for online external calibration may only relate to calibration between two (or more) sensors, not to the VRF.

The offline calibration procedure is problematic in that they require large and expensive calibration setups or equipment and the time for a skilled technician. Further, this one-time calibration procedure may hardly correct long-term sensor drift or detect erroneous calibration between drives, and thus may make the sensor information displayed in the VRF unreliable. Therefore, there is a need for a calibration procedure operated online while the vehicle is operated for its service life. Embodiments may provide such a process for the LiDAR sensor.

As long as AC is performed for at least one of the environment sensors, the other sensors may be calibrated indirectly with respect to the VRF through the existing online sensor-to-sensor calibration procedure. However, this violates the safety regulation of dualization and may expose potential calibration issues of the master sensor to all other sensors. Accordingly, embodiments may not rely on other ADAS sensors such as cameras, ultrasonic sensors, and radar.

Embodiments include a method for estimating the overall 6-DoF poses of an automotive LiDAR sensor with respect to the VRF with respective uncertainties without initial offline calibration when the vehicle is driven. This method may require the following information: the speed from an standard vehicle odometer sensor, i.e., a wheel encoder, and the yaw rate from an inertial measurement unit (IMU). Common LiDAR recognition software module, i.e., ground plane and ego motion estimation.

The AC algorithm may be ultra-lightweight, as it offloads all the heavy point cloud processing for other (upstream) modules used in ADAS/AD recognition architecture, which is for ground plane and ego motion estimation. In the case of the upstream recognition module, it has been demonstrated that the module can be run in real time on an automotive grade embedded board, at frequencies 20 Hz.

Embodiments may provide the following effects. The ADAS/AD system according to the embodiments may compensate for a long-term sensor pose drift and sense a change in sensor pose between drives. Since the embodiments do not rely on the calibration of other environment sensors, sensor redundancy may be maintained even when other sensors are incorrectly calibrated. Together with the 6-DoF pose, each uncertainty may be estimated, such that each consumer of the output (e.g., sensor fusion) may set an operational certainty threshold. The threshold may be used to store the converged AC results in a non-volatile memory (NVM). Accordingly, the latest AC may be provided at the start of each work cycle. As it does not rely on previous offline calibration procedures, it may be potentially obsolete, which may significantly save time and equipment for both the OEM assembly line and auto repair shop services.

Output definition according to embodiments:

A method according to embodiments may calculate an estimate with regard to the LiDAR pose. The VRF consisting of 6 parameters is configured as follows:

{x,y,z,Roll(ϕ),Pitch(θ),Yaw(ψ)},

where the first three elements may encode positions in Cartesian coordinates and the last three elements may encode directions at Tait-Bryan angles around the x, y and z axes, respectively. Also, the uncertainty of the estimate of each parameter may be calculated in the form of variance as follows:

{σₓ²,σ_{y}²,σ_{z}²,σ_{ϕ}²,σ_{θ}²,σ_{ψ}²}.

The VRF basically has its origin below the center of the rear axle at ground level. Instead, when a calibration is necessary for the center of the rear axle, the axle height should be measured and provided manually as it cannot be observed by the LiDAR and is simply subtracted from the estimated parameter z.

Drive-through access is a system that allows drivers to transact in stores without getting out of the vehicle. For example, fast food, restaurants, and other stores provide drive-through services to drivers and customers. Generally, to use a drive-through, vehicles line up, place an order, and pay. A queue for the drive-through service may include multiple lines, and a process including waiting, ordering, payment, and receiving may cause a lot of stress to the driver.

A vehicle, a vehicle control method and apparatus, and a recording medium according to the embodiments may efficiently automate the movement of the vehicle based on the vehicle queue(s), low-speed driving, merging into a single queue, safe parking and stopping for interaction with establishments (stores), and the like.

A vehicle, a vehicle control method and apparatus, and a recording medium according to the embodiments determine the location of the vehicle based on a drive-through using a sensor of the vehicle, detect other vehicles and pedestrians and determine the locations thereof using a sensor of the vehicle, and include drive-through assist (DTA) logic using the sensors of the vehicle. The vehicle, vehicle control method and apparatus, and recording medium according to the embodiments may use a sensor and/or a stored map to identify an appropriate location to drive and stop while safely navigating a drive-through.

Embodiments are intended to prevent the order number from being different from the location in the waitlist. In the process of arranging vehicles in a queue, an issue such as the difference between the order number and the location in the waitlist may be addressed using a vehicle tracking method according to embodiments.

Embodiments may automate driving of vehicles along a drive-through queue and stop vehicles in a correct location to interact with a establishment.

The vehicle, the vehicle control method and apparatus, and the recording medium according to the embodiments may resolve an error of a difference between an order number, a payment order, and a receipt order that may occur in a process in which a vehicle merges into a single traffic lane of a building.

The vehicle, the vehicle control method and apparatus, and the recording medium according to the embodiments may allow vehicles to automatically stop at the correct location on the drive-through queue and to interact with the nearby establishments to safely interact with pedestrians and other vehicles.

Embodiments may eliminate the tedium and stress of manually navigating a drive-through.

With the vehicle, the vehicle control method and apparatus, and the recording medium according to the embodiments, the location of a vehicle/driver may be determined based on a drive-through using a sensor of the vehicle, and other vehicles and pedestrians may be detected using the sensor of the vehicle. In addition, appropriate locations where the vehicle is to drive and stop while safely navigating the drive-through may be identified using the sensor of the vehicle and/or a stored map.

With the vehicle, the vehicle control method and apparatus, and the recording medium according to the embodiments, a map preloaded in the vehicle may be used, or a pre-built map that is downloaded wirelessly from a server may be used when the vehicle enters a drive-through.

The vehicle, the vehicle control method and apparatus, and the recording medium according to the embodiments may build a map in the vehicle by monitoring a driver who manually searches for a drive-through, and then automatically search for the drive-through. The map may be wirelessly transmitted to a server for use by other visiting vehicles. In addition, other vehicles may improve the map and share the map again for the next vehicle.

The vehicle, the vehicle control method and apparatus, and the recording medium according to the embodiments may incorporate a wireless ordering function that allows the driver to place an order without using a designated order point mechanism.

The vehicle, the vehicle control method and apparatus, and the recording medium according to the embodiments may communicate wirelessly with the establishment. Also, instead of stopping at a pickup window with store staff, the vehicle may automatically park at a designated place to which the ordered food will be delivered. If the order is delayed, the vehicle may automatically park when instructed to park.

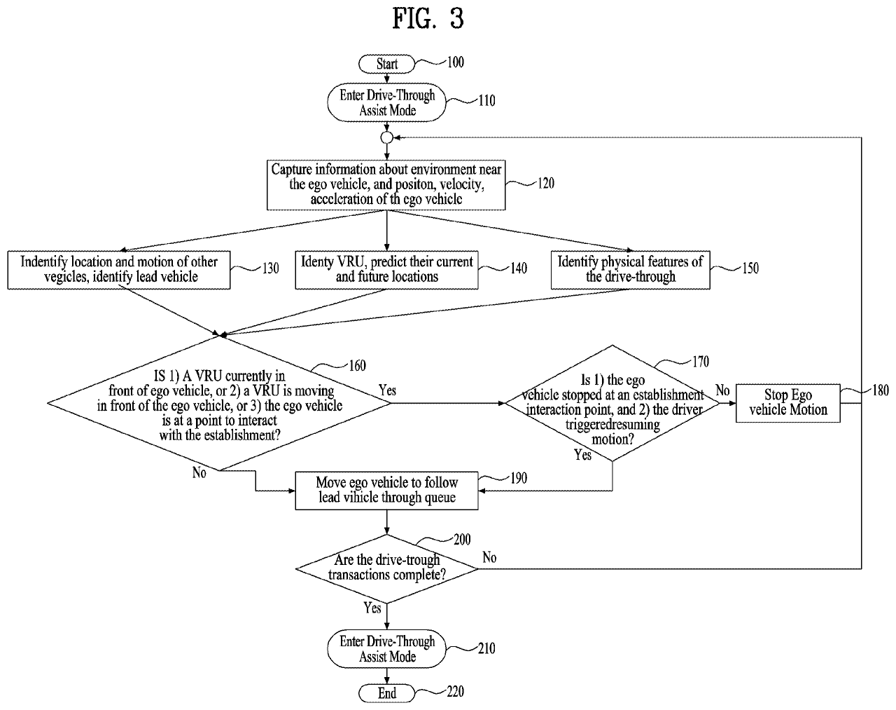

FIG. 3 illustrates a vehicle control method according to embodiments.

FIG. 3 is a flowchart illustrating a vehicle control method performed by the vehicle of FIGS. 1 and 2 according to embodiments.

Referring to operation 110, the vehicle control method according to the embodiments may include activating a drive-through assist mode.

Referring to operation 120, the vehicle control method according to the embodiments may include capturing (obtaining) information about an environment around an ego vehicle and the location, velocity, and acceleration of the ego vehicle. The ego vehicle according to the embodiments refers to a vehicle or system that is equipped with a computer system to collect data from various sensors of the vehicle, such as, for example, LIDAR, a monocular or stereoscopic camera, RADAR, and the like, and then analyze the collected data to control the vehicle in consideration of the location and motion of a related object (obstacle) in the environment.

Referring to operation 130, the vehicle control method according to the embodiments may further include identifying a location and motion of other vehicles and identifying a lead vehicle.

Referring to operation 130, the vehicle control method according to the embodiments may further include identifying a location and motion of other vehicles and identifying a lead vehicle.

Referring to operation 140, the vehicle control method according to the embodiments may further include identifying a vulnerable road user (VRU) and predicting a current and future location of the VRU.

Referring to operation 150, the vehicle control method according to the embodiments may further include identifying physical features of the drive-through.

Referring to operation 160, the vehicle control method according to the embodiments may include determining whether 1) a VRU is currently in front of the ego vehicle, 2) the VRU is currently moving in front of the ego vehicle, or 3) the VRU is at a point to interact with the establishment.

Referring to operation 170, the vehicle control method according to the embodiments may include determining whether 1) the ego vehicle has stopped at an establishment interaction point and 2) the driver has triggered a resuming motion. Operation 170 may be performed when the result of the determination in operation 160 is YES.

Referring to operation 180, the vehicle control method according to the embodiments may further include stopping the motion of the ego vehicle. Operation 180 may be performed when the result of the determination in operation 170 is NO.

Referring to operation 190, the vehicle control method according to the embodiments may further include moving the ego vehicle to follow the lead vehicle through the queue. Operation 190 may be performed when the result of the determination in operation 160 is NO or the result of the determination in operation 170 is YES.

Referring to operation 200, the vehicle control method according to the embodiments may further include determining whether the drive-through transaction is complete. When the result of the determination in operation 200 is NO, operation 120 is executed again.

Referring to operation 210, the vehicle control method according to the embodiments may further include exiting the drive-through assist mode.

In other words, as shown in FIG. 3, the vehicle, the vehicle control method/device, and the recording medium according to the embodiments include drive-through assist logic, and autonomously starts controlling the ego vehicle start when the driver enters the drive-through assist mode [110].

While the ego vehicle is in the drive-through assist mode, the logic may use information from vehicle sensors to identify and localize pedestrians and other vulnerable road users (VRU) [140], the physical features of the drive-through, such as lane markings and an interaction point [150], the position and motion of other vehicles [130], and relevant functions and actors in the environment [120], such as motion and location.

While the vehicle moves through the vehicle queue, it is first determined whether a vehicle in front of the ego vehicle is moving, and when to move forward when a gap is formed. The logic checks if there is a pedestrian or another VRU in front of the ego vehicle, and checks if the driver is interacting with the establishment [160]. In the absence of these restrictions, the ego vehicle moves forward following the lead vehicle [190]. When there are no VRUs at risk and the driver has signaled that interaction with the establishment is complete [170], the vehicle will move forward [190]. Otherwise, the vehicle remains stationary until the next cycle [180]. When the driver completes the transaction [200], the ego vehicle exits the drive-through assist mode and returns control of the ego vehicle to the driver to complete the event [220].

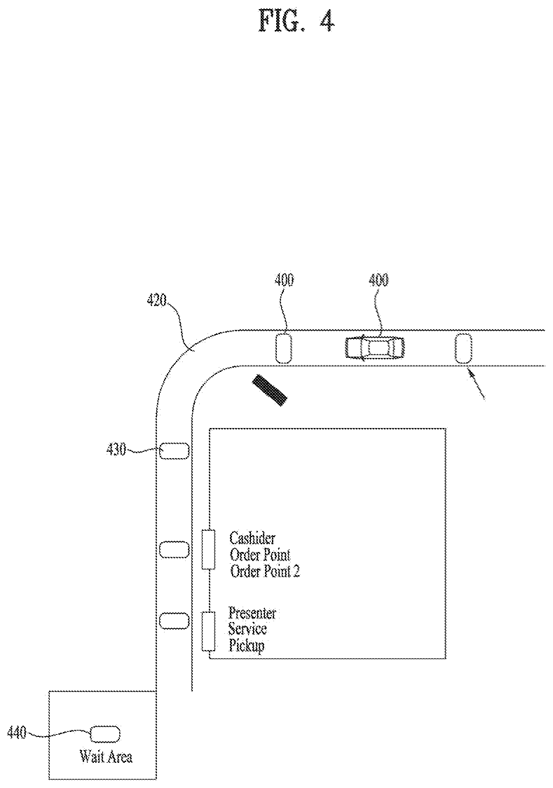

FIG. 4 illustrates drive-through control according to embodiments.

The vehicle according to FIGS. 1 and 2 may execute the drive-through assist mode as illustrated in FIG. 4 based on the method illustrated in FIG. 3.

In the embodiments, a vehicle 400 may be an ego vehicle. The vehicle 400 may be located at a point 410 for ordering food. The drive-through path for the vehicle 400 may be a single path 420. At the point 410, the driver may order food and make payment.

When the vehicle 400 arrives in the drive-through area, the drive-through assist mode may be executed. The driver may be informed that the drive-through assist mode is executed, through an arrival alert or the like.

The vehicle 400 may access an area 430 where a cashier is located. The driver may order food and make payment, and may wait in a queue to receive the ordered food.

The vehicle 400 may wait in an additional waiting space 440.

In the case of a single path as shown in FIG. 4, processes including arrival, order, payment, wait and receipt may be processed in order of vehicles entering the single path. Since the processes are performed along the single path, vehicle waiting time may increase.

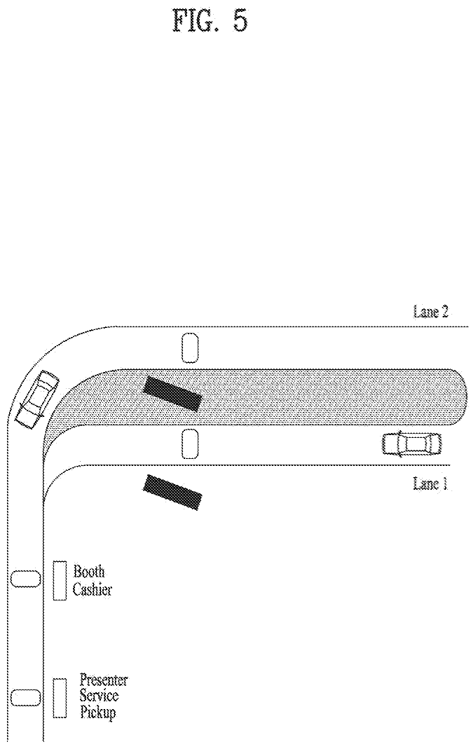

FIG. 5 illustrates drive-through control according to embodiments.

FIG. 5 shows an example in which a drive-through path includes multiple tracks, unlike the example of FIG. 4. For example, a vehicles may enter via multiple drive-through entry paths. When vehicles from which orders of menu have been received through multiple entrances are merged in a queue on a single path, a difference may occur between the order number and the waiting order depending on the driving state of the vehicle or information on the surrounding environment. This difference may cause stress to the drivers in terms of vehicle control or increase waiting time.

In the dry-through path environment shown in FIGS. 4 and 5, the ego vehicle shown in FIGS. 1 and 2 may efficiently and safely assist the driver in driving by the method as illustrated in FIG. 3.

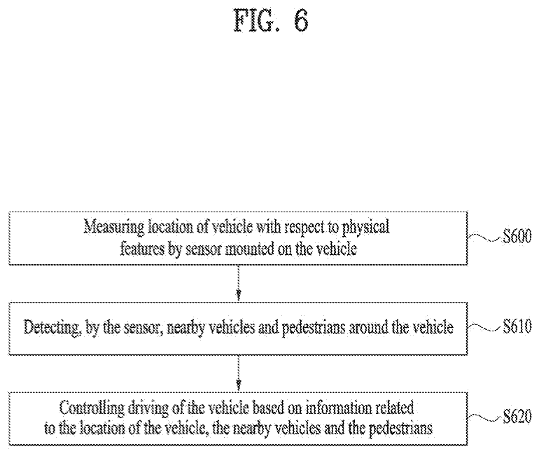

FIG. 6 illustrates a vehicle control method according to embodiments.

The vehicle of FIGS. 1 and 2 may be controlled based on the method illustrated in FIG. 6 for the drive-through control for FIGS. 3 to 5.

S600: The vehicle control method according to the embodiments may include measuring a location of a vehicle with respect to physical features by a sensor mounted on the vehicle. The operation of acquiring vehicle location information by the sensor may be performed by the sensor(s) mounted on the vehicle illustrated in FIGS. 1 and 2.

S610: The vehicle control method according to the embodiments may further include detecting nearby vehicles and pedestrians around the vehicle by the sensor. Detecting the vehicle vicinity information may include operations 120 to 150 illustrated in FIG. 3.

S620: The vehicle control method according to the embodiments may include controlling driving of the vehicle based on a location of the vehicle and information related to the nearby vehicles and pedestrians. The operation of controlling the vehicle may include operations 160 to 200 illustrated in FIGS. 3 to 6. Embodiments may safely and efficiently control the vehicle in consideration of the nearby environment of the vehicle in the exemplary drive-through environment illustrated in FIGS. 4 and 5.

Accordingly, embodiments may increase the convenience for a driver of a vehicle. Embodiments may effectively alleviate the burden and stress that the driver of the vehicle has to manually navigate the way for a drive-through. According to embodiments, the driver may easily and safely control the vehicle.

The embodiments have been described in terms of a method and/or an apparatus, and the description of the method and the description of the apparatus may be complementary to each other.

Although the accompanying drawings have been described separately for simplicity, it is possible to design new embodiments by combining the embodiments illustrated in the respective drawings. Designing a recording medium readable by a computer on which programs for executing the above-described embodiments are recorded as needed by those skilled in the art also falls within the scope of the appended claims and their equivalents. The devices and methods according to embodiments may not be limited by the configurations and methods of the embodiments described above. Various modifications can be made to the embodiments by selectively combining all or some of the embodiments. Although preferred embodiments have been described with reference to the drawings, those skilled in the art will appreciate that various modifications and variations may be made in the embodiments without departing from the spirit or scope of the disclosure described in the appended claims. Such modifications are not to be understood individually from the technical idea or perspective of the embodiments.

Various elements of the devices of the embodiments may be implemented by hardware, software, firmware, or a combination thereof. Various elements in the embodiments may be implemented by a single chip, for example, a single hardware circuit. According to embodiments, the components according to the embodiments may be implemented as separate chips, respectively. According to embodiments, at least one or more of the components of the device according to the embodiments may include one or more processors capable of executing one or more programs. The one or more programs may perform any one or more of the operations/methods according to the embodiments or include instructions for performing the same. Executable instructions for performing the method/operations of the device according to the embodiments may be stored in a non-transitory CRM or other computer program products configured to be executed by one or more processors, or may be stored in a transitory CRM or other computer program products configured to be executed by one or more processors. In addition, the memory according to the embodiments may be used as a concept covering not only volatile memories (e.g., RAM) but also nonvolatile memories, flash memories, and PROMs. In addition, it may also be implemented in the form of a carrier wave, such as transmission over the Internet. In addition, the processor-readable recording medium may be distributed to computer systems connected over a network such that the processor-readable code may be stored and executed in a distributed fashion.

In the present disclosure, “/” and “,” should be interpreted as indicating “and/or.” For instance, the expression “A/B” may mean “A and/or B.” Further, “A, B” may mean “A and/or B.” Further, “A/B/C” may mean “at least one of A, B, and/or C.” Also, “A/B/C” may mean “at least one of A, B, and/or C.” Further, in this specification, the term “or” should be interpreted as indicating “and/or.” For instance, the expression “A or B” may mean 1) only A, 2) only B, or 3) both A and B. In other words, the term “or” used in this document should be interpreted as indicating “additionally or alternatively.”

Terms such as first and second may be used to describe various elements of the embodiments. However, various components according to the embodiments should not be limited by the above terms. These terms are only used to distinguish one element from another. For example, a first user input signal may be referred to as a second user input signal. Similarly, the second user input signal may be referred to as a first user input signal. Use of these terms should be construed as not departing from the scope of the various embodiments. The first user input signal and the second user input signal are both user input signals, but do not mean the same user input signals unless context clearly dictates otherwise.

The terms used to describe the embodiments are used for the purpose of describing specific embodiments, and are not intended to limit the embodiments. As used in the description of the embodiments and in the claims, the singular forms “a”, “an”, and “the” include plural referents unless the context clearly dictates otherwise. The expression “and/or” is used to include all possible combinations of terms. The terms such as “includes” or “has” are intended to indicate existence of figures, numbers, steps, elements, and/or components and should be understood as not precluding possibility of existence of additional existence of figures, numbers, steps, elements, and/or components. As used herein, conditional expressions such as “if” and “when” are not limited to an optional case and are intended to perform the related operation or interpret the related definition according to a specific condition when the specific condition is satisfied.

Operations according to the embodiments described in this specification may be performed by a transmission/reception device including a memory and/or a processor according to embodiments. The memory may store programs for processing/controlling the operations according to the embodiments, and the processor may control various operations described in this specification. The processor may be referred to as a controller or the like. In embodiments, operations may be performed by firmware, software, and/or combinations thereof. The firmware, software, and/or combinations thereof may be stored in the processor or the memory.

The operations according to the above-described embodiments may be performed by the transmission device and/or the reception device according to the embodiments. The transmission/reception device may include a transmitter/receiver configured to transmit and receive media data, a memory configured to store instructions (program code, algorithms, flowcharts and/or data) for the processes according to the embodiments, and a processor configured to control the operations of the transmission/reception device.

The processor may be referred to as a controller or the like, and may correspond to, for example, hardware, software, and/or a combination thereof. The operations according to the above-described embodiments may be performed by the processor. In addition, the processor may be implemented as an encoder/decoder for the operations of the above-described embodiments.

What is claimed is:

1. A method for automatically driving a vehicle for a drive-through, the method comprising:
measuring a location of the vehicle with respect to physical features by a sensor mounted on the vehicle;
detecting, by the sensor, nearby vehicles and pedestrians around the vehicle; and
controlling driving of the vehicle based on information related to the location of the vehicle, the nearby vehicles, and the pedestrians.

2. The method of claim 1, wherein the physical features include lane markings and sign information for the vehicle.

3. The method of claim 1, further comprising:
moving or stopping the vehicle.

4. The method of claim 1, further comprising:
receiving a map for the vehicle,
wherein the map includes location information for the vehicle and information related to a place for the drive-through, and
wherein the vehicle is controlled based on the map.

5. The method of claim 4, wherein the map is received before the vehicle arrives at the place for the drive-through.

6. The method of claim 4, wherein the map is downloaded from a server based on a communication network when the vehicle is close to the place for the drive-through,
wherein the map is generated based on data collected in manually driving the vehicle for the drive-through,
wherein the map is transmitted to the nearby vehicles for the drive-through, and
wherein the map is updated in the vehicle and transmitted to the nearby vehicles.

7. A vehicle for providing automatic driving for a drive-through, comprising:
a sensor configured to measure a location of the vehicle with respect to physical features, the sensor being mounted on the vehicle; and
a processor configured to detect nearby vehicles and pedestrians around the vehicle by the sensor and to control driving of the vehicle based on information related to the location of the vehicle, the nearby vehicles, and the pedestrians.

8. The vehicle of claim 7, wherein the physical features include lane markings and sign information for the vehicle.

9. The vehicle of claim 7, wherein the processor is configured to move and stop the vehicle.

10. The vehicle of claim 7, wherein the processor is configured to receive a map for the vehicle,
wherein the map includes location information for the vehicle and information related to a place for the drive-through,
wherein the vehicle is controlled based on the map.

11. The vehicle of claim 10, wherein the map is received before the vehicle arrives at the place for the drive-through.

12. The vehicle of claim 10, wherein the map is downloaded from a server based on a communication network when the vehicle is close to the place for the drive-through;
wherein the map is generated based on data collected in manually driving the vehicle for the drive-through,
wherein the map is transmitted to the nearby vehicles for the drive-through,
wherein the map is updated in the vehicle and transmitted to the nearby vehicles.

13. A system for processing an order from a vehicle for a drive-through, comprising:
a communicator configured to receive menu information for ordering;
a display configured to display the menu information for the vehicle; and
a processor configured to receive an order from a driver or a passenger of the vehicle,
wherein the order is transmitted via the communicator.

14. The system of claim 13, wherein the communicator is configured to receive invoice information about the order,
wherein the display is configured to display the invoice information,
wherein the processor is configured to process a payment related to the invoice information, and
wherein the communicator is configured to transmit information about the payment.

15. A computer-readable recording medium storing:
data measured by a sensor of a vehicle and indicative of a location of the vehicle with respect to physical features;
data generated by detecting nearby vehicles and pedestrians around the vehicle; and
data for controlling driving of the vehicle based on information related to the location of the vehicle, the nearby vehicles, and the pedestrians.
